(19) United States
(12) Patent Application Publication
(10) Pub. No.: US 2020/0318302 A1
(43) Pub. Date: Oct. 8, 2020

(54) SNOW SHOVEL

(71) Applicant: Fabio Rueda, Saddle Brook, NJ (US)

(72) Inventor: Fabio Rueda, Saddle Brook, NJ (US)

(21) Appl. No.: 16/376,108

(22) Filed: Apr. 5, 2019

(51) Int. Cl. E01H 5/02; A01B 1/02; B25G 1/10

(52) U.S. Cl. CPC E01H 5/02; B25G 1/102; A01B 1/026

(57) ABSTRACT

A two-handled snow shovel is disclosed. The shovel includes a blade for carrying the snow, a lower shaft that extends from the upper edge of the blade angling forward substantially forty five degrees and upward and then connecting with an upper shaft forming another substantially forty five degree angle so that the upper shaft is substantially perpendicular to the ground, with a handle on the upper side of the upper shaft just behind the joining point, and ending in a second handle at the proximal end of the upper shaft.

### FIELD OF THE INVENTION

The present invention relates to the field of snow shovel construction. More particularly, this invention relates to a snow shovel ergonomically designed and constructed to be safely, comfortably and easily used to move snow, and may also be used to move dirt, sand and the like.

### BACKGROUND OF THE INVENTION

Snow shovels are widely used by owners of homes and businesses to remove snow from walkways, entrances and areas surrounding the home or business. Shoveling snow is often a tedious and tiring task, and moreover is frequently associated with injuries to those using the shovel.

Many innovations for shovels have been provided in the prior art. While many of these innovations have proven suitable for the specific purposes for which they were designed, they all differ from the present invention, for example devices such as those disclosed by U.S. Pat. Nos. 4,224,751; 4,231,604; 4,865,373; 5,074,064; 5,499,852; 5,918,921 and 9,163,372 which describe innovations

U.S. Pat. No. 4.224,751 to Schoemann teaches a snow removal device comprising a frame and a scoop; U.S. Pat. No. 4,231,604 to Obergfell teaches a shovel with a blade and elongated handle and laterally extending enlargement and pad acting as the fulcrum of a lever; U.S. Pat. No. 4,865,373 to Hudson teaches a manually operated snow shovel with wheels and an angularly bent handle; U.S. Pat. No. 5,074,064 to Nickels teaches a snow shovel with wheels for movement and swinging snow ejection plate; U.S. Pat. No. 5,499,852 to Seigendall teaches a second handle intended to keep the user from bending over and thereby reducing back injury and strain; U.S. Pat. No. 5,918, 921 to Samuelson teaches a levered snow shovel which is moved about on a single wheel; U.S. Pat. No. 9,163,372 to Elston teaches a three-handled snow shovel to overcome difficulties encountered with two handled shovels.

These patents show numerous innovations which may be suitable for the specific individual purposes that they address, but are not suitable for the purposes of the present invention as heretofore described.

### SUMMARY OF THE INVENTION

It is therefore an object of the present invention to provide a shovel for moving snow that avoids the disadvantages of the prior art.

It is a further object of the present invention to provide a shovel for moving snow that is simple and inexpensive to manufacture.

It is a further object of the present invention to provide a shovel for moving snow that is simple to use and ergonomically designed to reduce the need for the user bend over in order to avoid back injury and strain.

It is a further object of the present invention to provide a shovel for moving snow that may also be used to move sand, dirt and the like.

It is a further object of the present invention to provide a shovel for moving snow that includes a blade for carrying the snow, a lower shaft that extends from the blade angling forward substantially forty five degrees and upward and then connecting with an upper shaft forming another substantially forty five degree angle so that the shaft is substantially perpendicular to the ground, with a handle just attached to the upper side of the upper shaft beyond the joining point, and ending in a second handle.

It is a further object of the present invention to provide a shovel for moving snow that includes a blade for carrying the snow, a lower shaft that extends from the blade angling forward substantially forty five degrees and upward and then connecting with an upper shaft forming another substantially forty five degree angle so that the shaft is substantially perpendicular to the ground, with a handle just attached to the upper side of the upper shaft beyond the joining point, and ending in a second handle, with gloves or mittens mechanically attached to each of the two handles, allowing users to slip their hands into said gloves or mittens when gripping the handles, providing for improved grip, comfort and protection against the cold and injury caused by friction or abrasion.

This summary is provided merely to introduce certain concepts and not to identify key or essential features of the claimed subject matter. These and other features of the invention can be further understood by reference to the following drawings.

### BRIEF DESCRIPTION OF THE DRAWINGS

FIG. 1 is a side perspective view of the shovel of the present invention in accordance with the present disclosure.

FIG. 2 is a side view of the shovel of the present invention in accordance with the present disclosure.

FIG. 3 is a top view of the shovel of the present invention in accordance with the present disclosure.

FIG. 4 is a side view of the shovel of the present invention to illustrate an embodiment including a glove mitten mechanically attached to each of the two handles.

### DETAILED DESCRIPTION OF THE INVENTION

Various embodiments of the present invention will be described in detail with reference to the drawings. Reference to various embodiments does not limit the scope of the invention, which is limited only by the scope of the claims attached hereto. Additionally, any examples or applications set forth in this specification are not intended to be limiting and merely set forth some of the many possible embodiments for the claimed invention. For example, while the present invention has an application for use with snow shovels, it is anticipated that the present invention may have application in other forms of shovels and other tools used in the lifting and moving of materials such as dirt, sand, hay, grass, grain or coal.

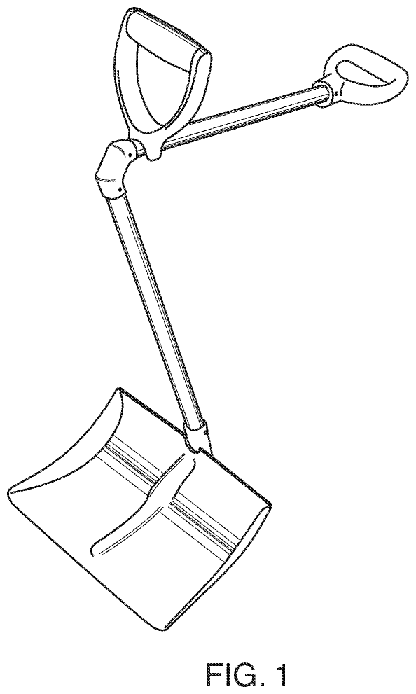

As shown in FIG. 1, the snow shovel of the present invention includes a blade for carrying the snow, having a concave front surface and a convex rear surface, a lower edge and an upper edge which upper edge receives the lower end of the lower shaft. The lower end of the lower shaft extends from the upper edge of the blade forming an angle of substantially forty five degrees. The upper end of the lower shaft is mechanically attached to the distal end of the upper shaft extending toward the proximal end at an angle of substantially forty five degrees, substantially perpendicular to the ground. A handle, preferably D shaped is attached to the proximal end of the upper shaft. A second handle, preferably D shaped is attached to the distal end of the upper shaft to enable the user to more easily use and manipulate the shovel of the present invention.

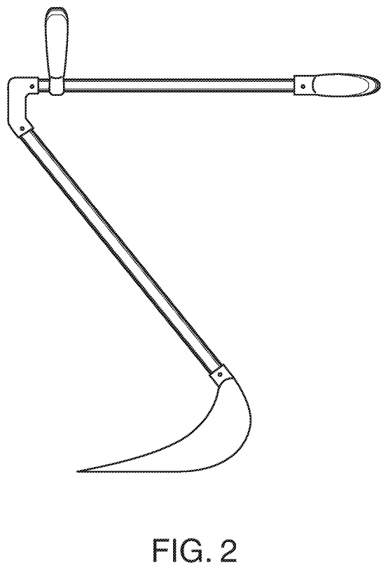

As shown in FIG. 2, the snow shovel of the present invention includes a blade for carrying the snow, having a concave front surface and a convex rear surface, a lower edge and an upper edge which upper edge receives the lower end of the lower shaft. The lower end of the lower shaft extends from the upper edge of the blade forming an angle of substantially forty five degrees. The upper end of the lower shaft is mechanically attached to the distal end of the upper shaft extending toward the proximal end at an angle of substantially forty five degrees, substantially perpendicular to the ground. A handle, preferably D shaped is attached to the proximal end of the upper shaft. A second handle, preferably D shaped is attached to the distal end of the upper shaft to enable the user to more easily use and manipulate the shovel of the present invention.

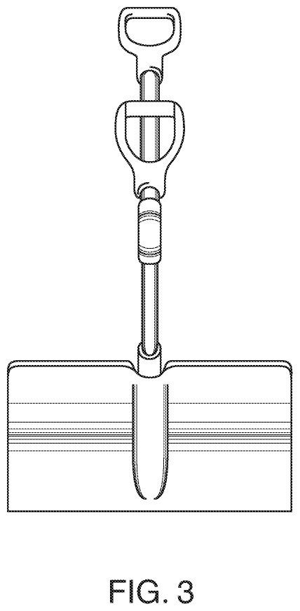

As shown in FIG. 3, the snow shovel of the present invention includes a blade for carrying the snow, having a concave front surface and a convex rear surface, a lower edge and an upper edge which upper edge receives the lower end of the lower shaft. The lower end of the lower shaft extends from the upper edge of the blade forming an angle of substantially forty five degrees. The upper end of the lower shaft is mechanically attached to the distal end of the upper shaft extending toward the proximal end at an angle of substantially forty five degrees, substantially perpendicular to the ground. A handle, preferably D shaped is attached to the proximal end of the upper shaft. A second handle, preferably D shaped is attached to the distal end of the upper shaft to enable the user to more easily use and manipulate the shovel of the present invention.

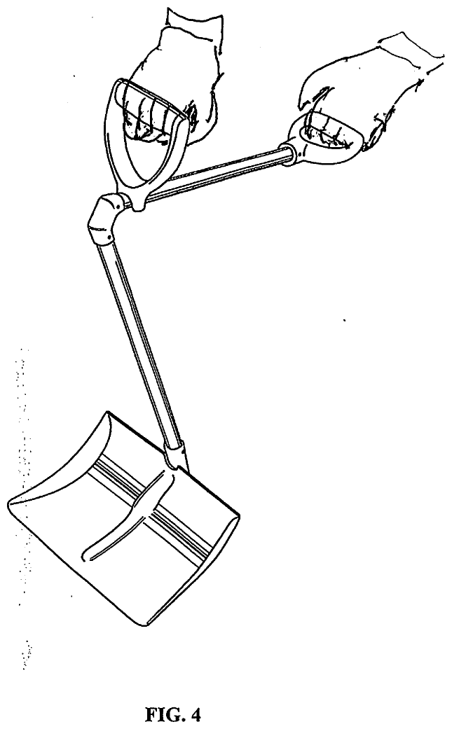

As shown in FIG. 4, the snow shovel of the present invention includes a blade for carrying the snow, having a concave front surface and a convex rear surface, a lower edge and an upper edge which upper edge receives the lower end of the lower shaft. The lower end of the lower shaft extends from the upper edge of the blade forming an angle of substantially forty five degrees. The upper end of the lower shaft is mechanically attached to the distal end of the upper shaft extending toward the proximal end at an angle of substantially forty five degrees, substantially perpendicular to the ground. A handle, preferably D shaped is attached to the proximal end of the upper shaft. A second handle, preferably D shaped is attached to the distal end of the upper shaft to enable the user to more easily use and manipulate the shovel of the present invention. A glove or mitten is mechanically attached to each of the two handles, allowing users to slip their hands into said gloves or mittens when gripping the handles, providing for an improved grip, protection and comfort against cold and damage by friction or abrasion.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

What is claimed is:

1. A shovel, comprising:
a blade for carrying the snow wherein said blade is wide, thin and substantially rectangular-shaped with a rearmost edge thereof which is upturned, and a forward most edge thereof for scooping the snow; and
a lower shaft extending from the upper edge of said blade at substantially a forty five degree angle, mechanically connected to an upper shaft having proximal and distal ends defining a transverse axis, said upper shaft forming an angle of approximately forty five degrees with said lower shaft so that said upper shaft is substantially perpendicular to the ground;
a first handle mechanically attached to the proximal end of said upper shaft;
said 45 degree angle is formed by the upper part and lower part of a single and only shaft connected to the blade;
a second handle mechanically attached to the upper side of the distal end of said upper shaft;
said shovel does not include multiple shafts connected to the blade.

2. The shovel of claim 1 wherein a glove or mitten is mechanically attached to each of the two handles, allowing the users to slip their hands into said gloves or mittens when gripping the handles, providing for an improved grip and also protection and comfort against cold and damage by friction or abrasion.
